(19) United States
(12) Patent Application Publication
(10) Pub. No.: US 2014/0351232 A1
(43) Pub. Date: Nov. 27, 2014

(54) ACCESSING ENTERPRISE DATA USING A NATURAL LANGUAGE-BASED SEARCH

(71) Applicants: Yang-Cheng Fan, San Jose, CA (US); Jenngang Shih, Santa Clara, CA (US); Zhong Zhang, Los Altos, CA (US)

(72) Inventors: Yang-Cheng Fan, San Jose, CA (US); Jenngang Shih, Santa Clara, CA (US); Zhong Zhang, Los Altos, CA (US)

(73) Assignee: SAP AG, Walldorf (DE)

(21) Appl. No.: 13/899,412

(22) Filed: May 21, 2013

(51) Int. Cl. G06F 17/30

(52) U.S. Cl. CPC G06F 17/30864
USPC 707/706; 707/769; 707/771

(57) ABSTRACT

Enterprise data can be accessed via a natural language user interface. In one embodiment, a mobile application can receive voice data and text data corresponding to the voice data. A conversion from voice to text can be performed by the mobile application or a third-party dictation service. Based on the text data, a command can be generated for use by a business analytics engine or by an enterprise search engine. In the case of the business analytics engine, it can perform analysis on the retrieved enterprise data, such as by applying business algorithms on the retrieved enterprise data in order to generate analytical results. In the case of the enterprise search engine, it can perform a search of enterprise data based on the command. In either case, results can be presented to the user on a user interface.

### BACKGROUND

Natural Language User Interfaces (LUI or NLUI) are a type of computer human interface where linguistic phenomena such as verbs, phrases and clauses act as UI controls for creating, selecting and modifying data in software applications. Applications use a natural language user interface to answer questions, make recommendations, and perform actions by delegating requests to a set of Web services. Some of the actions that can be performed include finding recommendations for nearby restaurants, getting directions, etc.

In the business context, NLUIs have been largely ineffective as they are used for generic Internet searches and have not focused on accessing and analyzing business data. As such, there is a need to extend NLUIs to the business context.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Enterprise data can be accessed via a natural language user interface. In one embodiment, a mobile application can receive voice data and text data corresponding to the voice data. The conversion from voice to text can be performed by the mobile application or a third-party dictation service. Based on the text data, a command can be generated for use by a business analytics engine or by an enterprise search engine. In the case of the business analytics engine, it can perform analysis on the retrieved enterprise data, such as by applying business algorithms on the analyzed enterprise data in order to generate analytical results. In the case of the enterprise search engine, it can perform a search of the enterprise data based on the command. In either case, search results can be presented to the user on a user interface.

In another embodiment, the command can be received and interpreted by an interface associated with a server computer. The interface can then selectively control either the business analytics engine or the enterprise search engine for accessing a plurality of enterprise databases. The results can be passed back to a mobile application for consumption by a user.

The foregoing and other objects, features, and advantages will become more apparent from the following detailed description, which proceeds with reference to the accompanying figures.

### BRIEF DESCRIPTION OF THE DRAWINGS

FIG. 1 is a system view according to one embodiment wherein a mobile application can display enterprise-based analytical results obtained from a business analytics engine and/or search results obtained from an enterprise search engine with Natural Language Processing (NLP) occurring on a client device.

FIG. 2 is a system view according to another embodiment wherein NLP occurs on a server computer.

FIG. 3 is an embodiment wherein an interface is used to communicate between a mobile application and a server computer using an Internet protocol.

FIG. 4 is an embodiment illustrating an exemplary NLP to generate commands from text data.

FIG. 5 is a flowchart of a method for searching enterprise data using voice commands.

FIG. 6 is a flowchart of another embodiment for searching enterprise data using voice commands.

FIG. 7 is a flowchart of an embodiment for generating a command using the NLP.

FIG. 8 is an example mobile device that can be used with any of the embodiments described herein.

FIG. 9 is an exemplary computing environment that can be used with any of the embodiments described herein.

### DETAILED DESCRIPTION

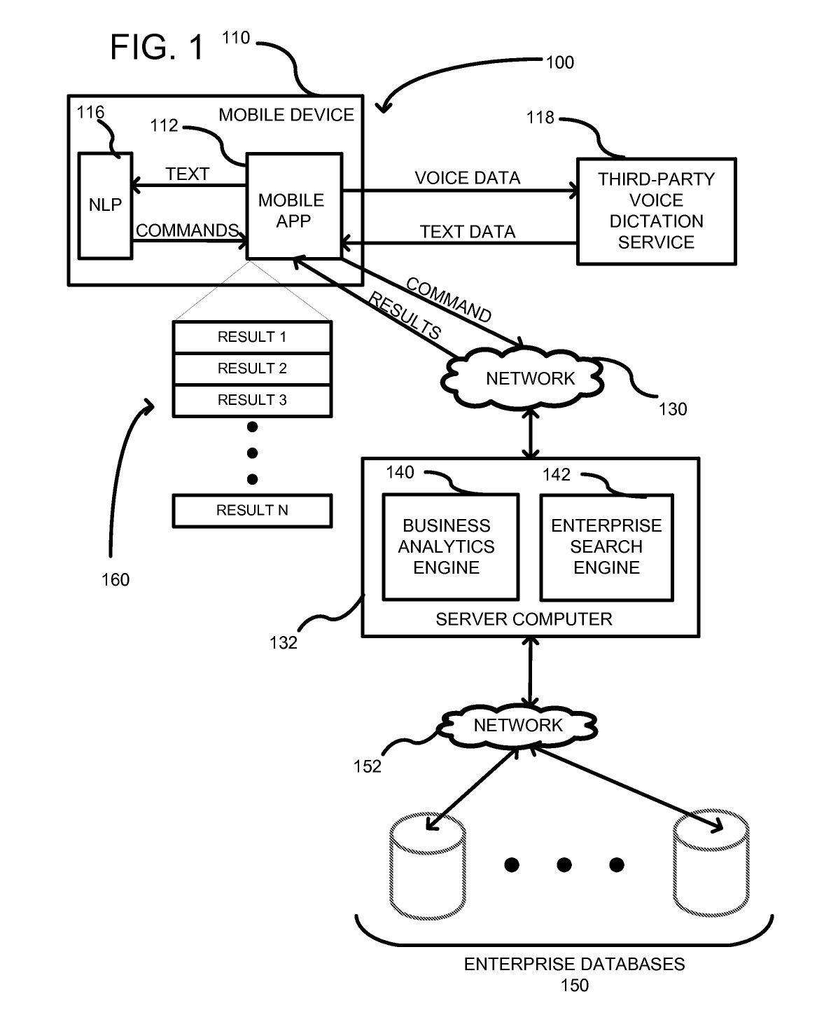

FIG. 1 is a system view 100 according to one embodiment that can perform natural language-based searches to access enterprise data. In this embodiment, a mobile device 110 includes a mobile application 112 that can receive voice commands from a user using a natural language user interface (not shown in FIG. 1). A natural language processing (NLP) algorithm 116 can be coupled to the mobile application 112. The NLP 116 can be any of a variety of commercially available NLPs or can be customized according to design needs. An example NLP is described further below. Whatever NLP is used, it generally receives input text data and outputs commands used to control searching of enterprise data. A third-party voice dictation service 118 can also be coupled to the mobile application 112 through a network, such as the Internet. In alternative embodiments, the third-party voice dictation service 118 can be located on the mobile device 110, or can be part of the mobile application 112. The mobile application 112 can transmit received voice data (i.e., the voice commands) to the third-party voice dictation service 118, and receive text data corresponding to the voice data in return. Thus, the third-party voice dictation service converts the voice data to text using well-known speech recognition technology. Any desired voice dictation service can be used, as such services are well-developed in the art. After the mobile application 112 receives the text data from the dictation service 118, it can send the text data to the NLP for processing. The NLP can generate one or more commands based on the received text and transmit the one or more commands to the mobile application 112. The mobile application 112, in turn, can transmit the one or more commands over a network 130 to a server computer 132.

The server computer 132 can be an enterprise server including one or more enterprise-based application engines thereon. For example, a first application engine can be a business analytics engine 140 and a second search engine can be an enterprise search engine 142. In some embodiments, the server computer 132 can selectively choose either engine 140, 142 depending on the command received from the mobile application 112. The business analytics engine 140 can access proprietary enterprise logics 150 in enterprise databases via a network 152 and retrieve analytical data. The analytical data can include customer-specific data, such as location, contact person, sales data, customer lists, customer products, warehousing data, production data, inventory data, transportation, security, material handling, etc. Thus, the analytical data can be any customer logistical data used for management of customer resources. The business analytics engine 140 can then perform algorithmic analysis on the analytical data to generate a ranked list 160 of search results. The business analytics algorithm can perform analysis on the analytical data, such as by making statistical analysis, quantitative analysis, explanatory and predictive modeling to make intelligent decisions about the ranking of the results 160.

The enterprise search engine 142 can also access the enterprise logics 150 via the network 152. Unlike generic search engines that search the Internet, the enterprise search engine 142 can limit its search to the enterprise logics 150 or can combine the data from the enterprise data with Internet-based search results. The enterprise search engine 142 can use key words obtained through the command received from the mobile application 112 in order to generate the ranked listing 160 of the best-matching enterprise data. The search engine algorithm is particularly targeted to analysis of enterprise data and can use similar techniques as the business analytics algorithm, already discussed.

Although two different engines 140, 142 are shown, the embodiment can be extended to include other enterprise-based engines or sub-engines, including a forecasting engine, a predictive analysis engine, etc.

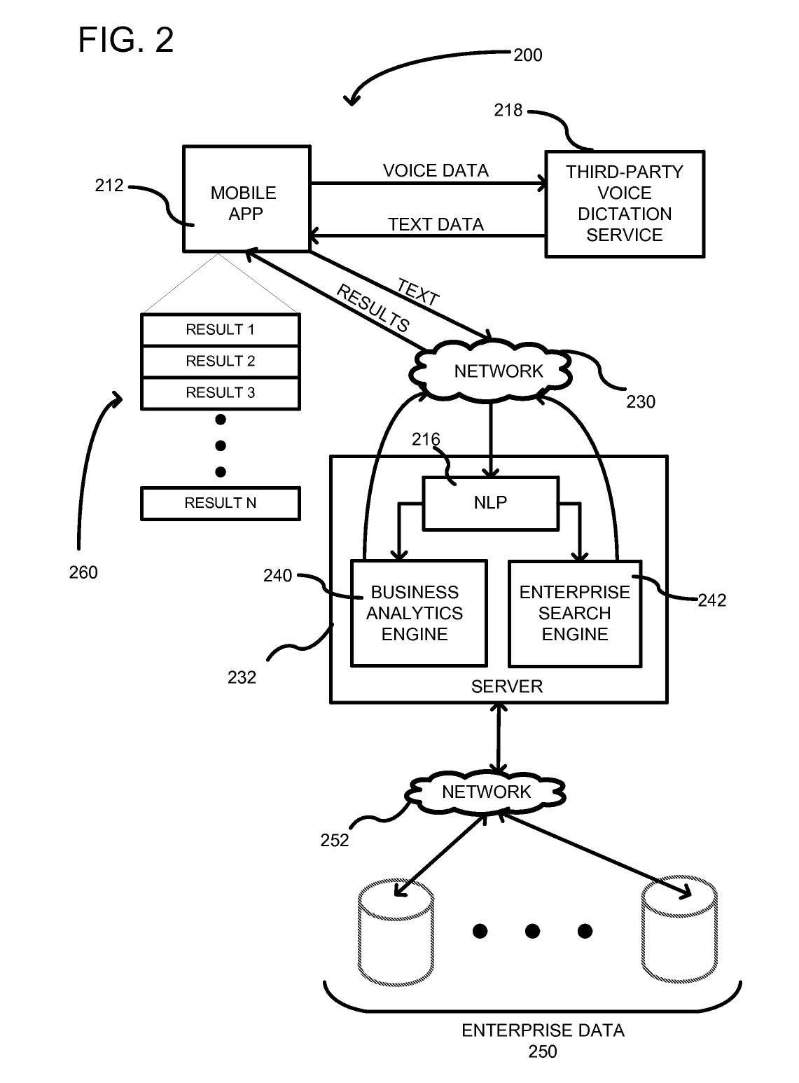

FIG. 2 shows another embodiment of a system 200 that can be used to perform natural language searches for accessing (retrieving and/or examining) enterprise data. In this embodiment, a mobile application 212 can receive voice data through a user interface and can transmit the voice data to a third-party voice dictation service 218, similar to FIG. 1. The mobile application 212 can then receive text data from the third-party voice dictation service 218. Rather than performing natural language processing on a client device, the mobile application 212 can transmit the text data over a network 230 to an enterprise-based server computer 232. The server computer 232 can include an NLP 216 that can receive the text data and generate commands in response thereto. If a command is based on a business-analytics function, then the command can be passed from the NLP 216 to a business analytics engine 240. Alternatively, if the command is based on an enterprise search, an enterprise search engine 242 can be invoked in order to process the command. In any event, one or both of the engines 240, 242 can retrieve enterprise logics 250 in enterprise databases via a network 252 in order to generate search results. The search results can be transmitted back to the mobile application 212 to display a list of results 260 on a mobile device display.

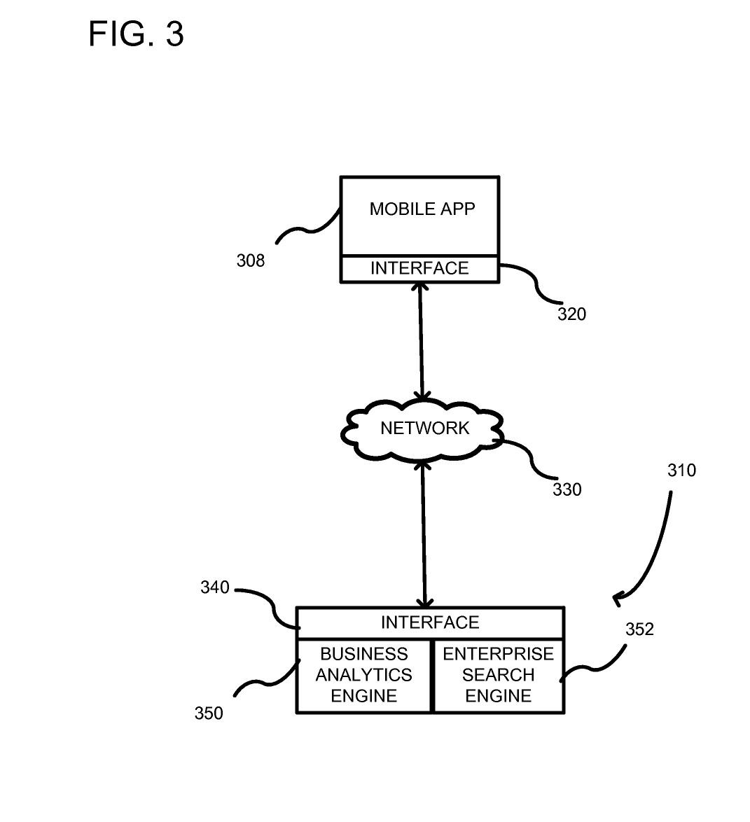

FIG. 3 shows additional components that can be included to enhance communication between a mobile application 308 and an enterprise-based server computer 310. The mobile application 308 can use an interface 320 that transforms communications from the mobile application 308 so that they are suitable for transmission over a network 330 using an Internet protocol. Likewise, communications received from the network 330 can be transformed from an Internet protocol into packets understood by the mobile application. For example, a list of search results can be extracted from an IP message received from the network 330. The server computer 310 can also have an Internet-based interface 340. The interface 340 can transform Internet packets into packets readable by either a business analytics engine 350 or an enterprise search engine 352. The interface 340 can include intelligence for passing the packets to the proper engine 350, 352, or the interface can pass the packets to both engines and the engines 350, 352 can decide based on the command or addressing whether they should act on the packet. In an alternative embodiment (not shown), the interface 340 can be coupled to an NLP, such as that shown in FIG. 2 at 216.

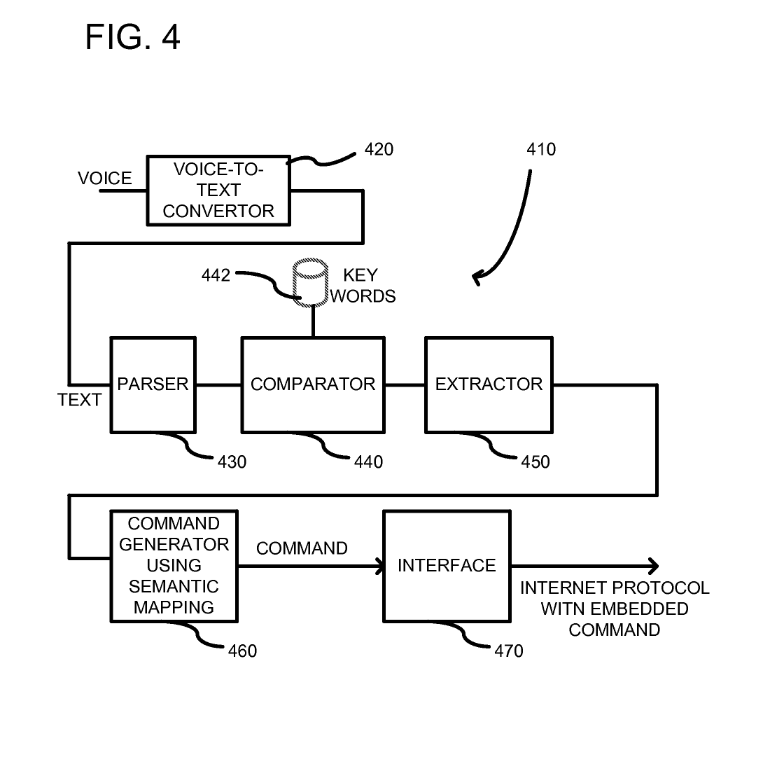

FIG. 4 shows an example embodiment of an NLP 410 that can be used with any of the embodiments described herein. A voice-to-text converter 420 may or may not be part of the NLP. The converter 420 receives voice data and converts it to text using well-known speech-recognition software. The text data then passes to a parser 430. The parser analyzes a string of the text data in accordance with rules of formal grammar in order to break the text data into its constituent parts. A parse tree showing a syntactic relationship between words can also be generated. A comparator 440 is coupled to the parser and compares the parsed text data to key words stored in a database 442. Key words assist in identifying commands that the user intended through their voice command. The comparator 440 can be coupled to an extractor 450 that extracts the key words identified by the comparator 440 from the text data. The extracted words can then be passed to a command generator 460 that can perform a semantic mapping of the key words in order to generate a command that is understandable by one of the engines. The command can then be passed to an interface 470, which transforms the command so that it can be transmitted using an Internet-based protocol.

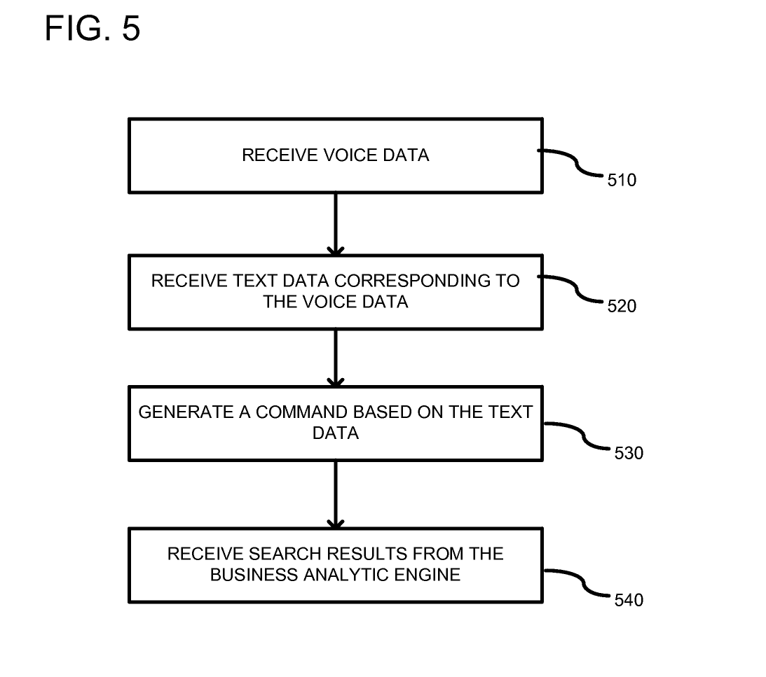

FIG. 5 is a flowchart of a method for accessing enterprise data using a natural language user interface. In process block 510, voice data is received using a microphone or other input device. The input device can be on a mobile device or other computer device, and need not necessarily be handheld. In process block 520, text data is received corresponding to the voice data. The text data can be received in response to transmission of the voice data to a third-party voice dictation service or other voice-to-text converters. In process block 530, a command can be generated based on the text data so as to interface with a business analytics engine or an enterprise-based search engine. For example, the text data can be parsed, compared to key words, and extracted so as to generate a command. Semantic mapping between the key words and the command can also be performed. The command can then be transmitted to a business analytics engine over a network via an interface for analysis. Once the command is received by the business analytics engine, it executes the function corresponding to the command and generates analytical results. In process block 540, the analytical results can be received on the client device from the business analytic engine. Once received, the analytical results can be post-processed and displayed to the user on the client device. The analytical results can be in the form of a list, each item being selectable to retrieve additional information about the result from the enterprise databases.

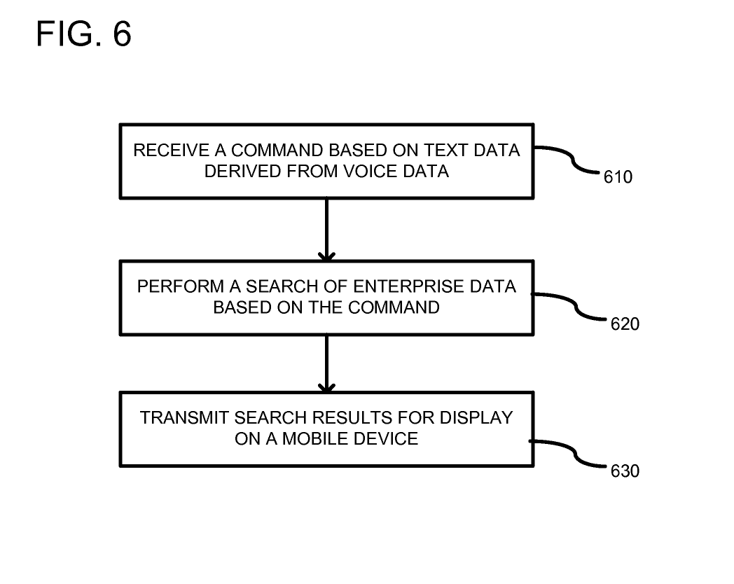

FIG. 6 is a flowchart according to another embodiment for accessing enterprise data using a natural language user interface. In process block 610, a command is received based on text data derived from voice data. Using the text data, commands can be generated using semantic mapping, for example. The commands can be received from a mobile device. In process block 620, a search is performed of enterprise data based on the received command. The search can be performed by an enterprise search engine, which can search enterprise databases based on the command. Alternatively, the search can be performed by a business analytics engine. In any event, when the search is completed, a list of results can be generated and transmitted for display on a mobile device or other client device (process block 630).

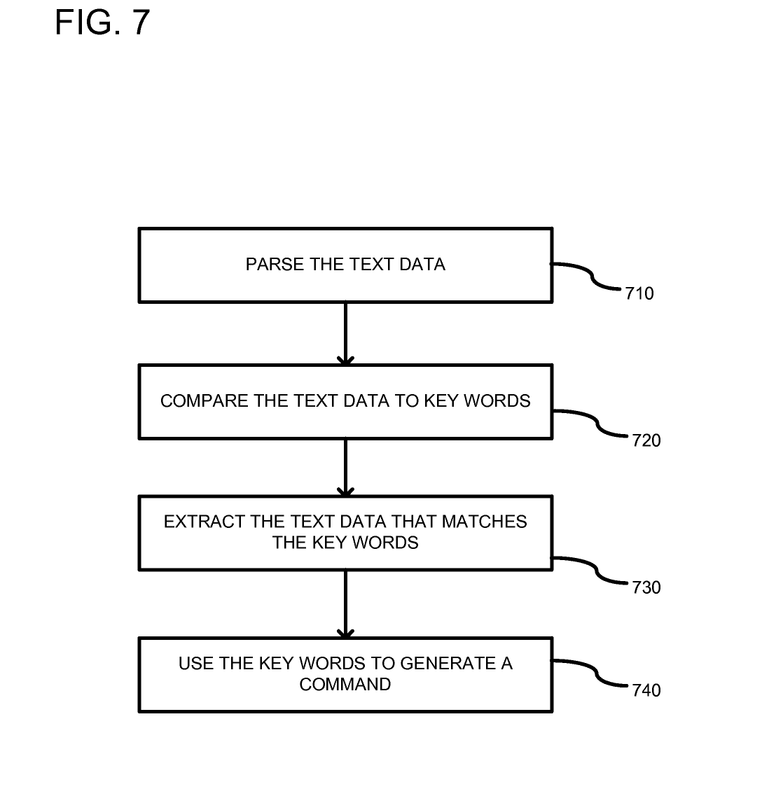

FIG. 7 is a flowchart of a method for generating a command based on text data derived from received voice data. In process block 710, the text data can be parsed to divide the data into parts, which can include one or more words. In process block 720, the parsed text data can be compared to key words used in commands. In process block 730, the text data that matches key words can be extracted in order to generate commands. In process block 740, the key words can be used to generate a command designed to control an engine on a system server computer, such as a business analytics engine or an enterprise search engine. Generation of the command can include performing a semantic mapping between the key words and the command. Once the command is generated it can, for example, be passed to the business analytics engine that can access enterprise data associated with the command. Business algorithms can then be applied on the data to generate search results. In one example, the business analytics engine can access enterprise-based calendar information that is associated with the mobile device and that is stored amongst the enterprise data. Thus, a user of the mobile device can access calendar information which is stored on a remote data base, and which can be analyzed by a business analytics engine in order to provide results of a command request.

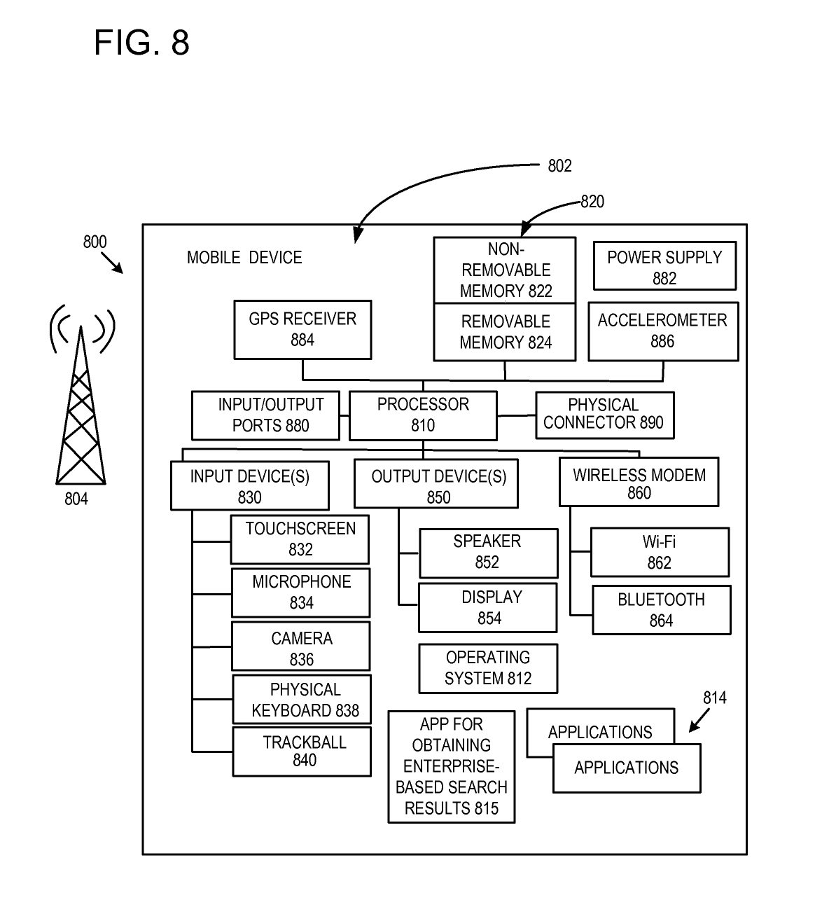

FIG. 8 is a system diagram depicting an exemplary mobile device 800 including a variety of optional hardware and software components, shown generally at 802. Any components 802 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 804, such as a cellular or satellite network.

The illustrated mobile device 800 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components 802 and support for one or more application programs 814. The application programs can include common mobile computing applications (e.g., email applications, calendars, contact managers, web browsers, messaging applications), or any other computing application. A particular application that can be used in the embodiments described herein is an application for obtaining enterprise-based search results 815, which can interact with a business analytics search engine or an enterprise search engine for retrieving such results.

The illustrated mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touchscreen 832, microphone 834, camera 836, physical keyboard 838 and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User interface (NU). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. In such an implementation where voice data can be received and interpreted, the device is acting as a natural language user interface. Further, the device 800 can comprise input devices and software that allows for user interaction via a user's spatial gestures, such as detecting and interpreting gestures to provide input to a gaming application.

A wireless modem 860 can be coupled to an antenna (not shown) and can support two-way communications between the processor 810 and external devices, as is well understood in the art. The modem 860 is shown generically and can include a cellular modem for communicating with the mobile communication network 104 and/or other radio-based modems (e.g., Bluetooth 864 or Wi-Fi 862). The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can be deleted and other components can be added.

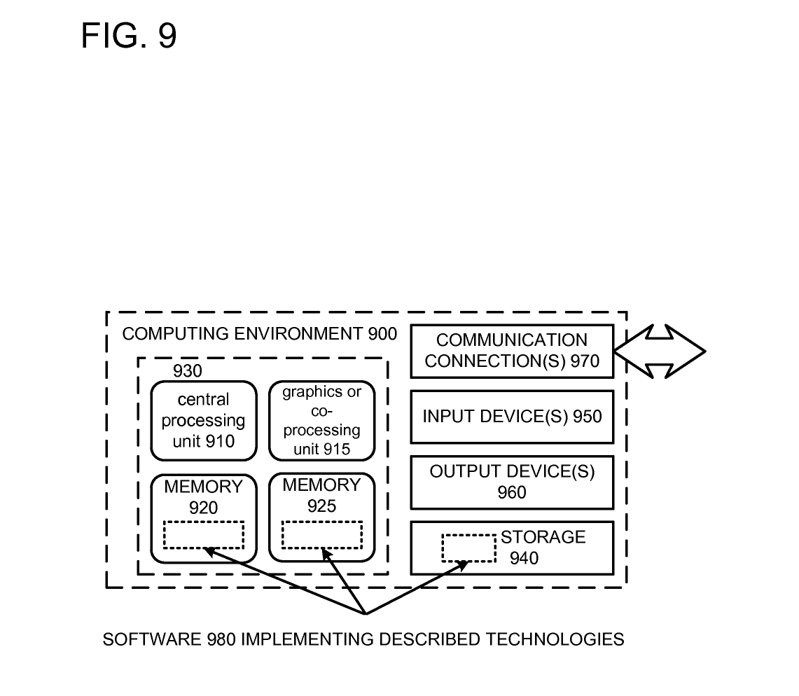

FIG. 9 depicts a generalized example of a suitable computing environment 900 in which the described innovations may be implemented. The computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, media player, gaming system, mobile device, etc.)

With reference to FIG. 9, the computing environment 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. For video encoding, the input device(s) 950 may be a camera, video card, TV tuner card, or similar device that accepts video input in analog or digital form, or a CD-ROM or CD-RW that reads video samples into the computing environment 900. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed embodiments may be applied, it should be recognized that the illustrated embodiments are only preferred examples and should not be taken as limiting the scope herein. Rather, the scope of this disclosure is defined by the following claims. We therefore claim all that comes within the scope of these claims.

We claim:

1. A method of accessing enterprise data, comprising:
receiving voice data;
receiving text data that corresponds to the voice data;
generating a command based on the text data, the command used to interface with a business analytics engine; and
receiving analytical results from the business analytics engine, the business analytics engine performing analysis on retrieved enterprise data in accordance with the command to obtain the search results.

2. The method of claim 1, wherein generating the command includes parsing the text data, comparing the text data to key words, extracting the text data that matches the key words and using the extracted text data to generate the command.

3. The method of claim 2, wherein generating the command further includes performing a semantic mapping between the key words and the command.

4. The method of claim 1, further including receiving the command in the business analytics engine, retrieving data associated with the command and applying business algorithms on the data in order to generate the analytical results.

5. The method of claim 4, further including receiving the command in an interface coupled to the business analytics engine, the interface for receiving the command using an Internet protocol.

6. The method of claim 1, further including transmitting the command to the business analytics engine via a network.

7. The method of claim 1, wherein the voice data is received on a mobile device and the business analytics engine accesses calendar information associated with the mobile device that is stored amongst enterprise data accessible by the mobile device over the network.

8. The method of claim 1, wherein the network is the Internet and the business analytics engine includes an interface for receiving command, which is Internet-protocol based.

9. The method of claim 1, wherein receiving voice data includes using an application on a mobile device to receive the voice data and the method further includes transmitting the voice data to a third-party voice dictation service.

10. The method of claim 9, wherein receiving text data includes receiving the text data from the third-party dictation service.

11. One or more computer-readable storage medium for executing a method for accessing enterprise data using a mobile device, the method comprising:
receiving a command based on text data derived from voice data, the command for directing an enterprise search engine;
performing a search of enterprise data based on the command; and
transmitting search results from the enterprise search engine for display on a mobile device.

12. The computer-readable storage medium of claim 11, further including generating the command including parsing the text data, comparing the text data to key words, extracting the text data that matches the key words and using the extracted text data to generate the command.

13. The computer-readable storage medium of claim 12, wherein generating the command further includes performing a semantic mapping between the key words and the command.

14. The computer-readable storage medium of claim 11, further including receiving voice data in an application on the mobile device and converting the voice data to text data.

15. The computer-readable storage medium of claim 14, wherein converting the voice data to text data includes transmitting the voice data to a third-party dictation service and receiving from the third-party dictation service, the text data derived from the voice data.

16. The computer-readable storage medium of claim 11, further including using a business analytics engine to access enterprise data stored in one or more enterprise databases.

17. The computer-readable storage medium of claim 16, wherein the business analytics engine generates a list of search results based on enterprise data input into an algorithm associated with the command.

18. A system for accessing enterprise data, comprising:
a business analytics engine in a server computer;
an enterprise search engine in the server computer;
a plurality of enterprise databases coupled to both the business analytics engine and the enterprise search engine; and
wherein a command is received by the server computer, the command being derived from voice data and selectively controlling either the business analytics engine or the enterprise search engine for accessing the plurality of enterprise databases.

19. The system of claim 18, further including
a parser for receiving text data that is derived from the voice data and for dividing the text data into component parts;
a comparator for comparing the component parts to key words;
an extractor for extracting the component parts that match the key words; and
a command generator for generating the command to be used with either the business analytics engine that performs an analysis of enterprise data in accordance with the command or the enterprise search engine that performs a search of the enterprise databases in accordance with the command.

20. The system of claim 18, further including a voice-to-text convertor for converting voice data into the text data.
